(19) United States
(12) Patent Application Publication
(10) Pub. No.: US 2024/0420395 A1
(43) Pub. Date: Dec. 19, 2024

(54) SYSTEMS AND METHODS FOR GENERATING DYNAMIC VIRTUAL REPRESENTATIONS OF AN OBJECT OR EVENT

(71) Applicant: Capital One Services, LLC, McLean, VA (US)

(72) Inventors: Amy Jean LA, Brandon, FL (US); Kevin OSBORN, Newton Highlands, MA (US)

(73) Assignee: Capital One Services, LLC, McLean, VA (US)

(21) Appl. No.: 18/335,707

(22) Filed: Jun. 15, 2023

(51) Int. Cl. G06T 11/60

(52) U.S. Cl. CPC G06T 11/60; G06T 2200/24

(57) ABSTRACT

A method for generating a dynamic virtual representation of an event or an object is disclosed. The method includes obtaining one or more of first data or first metadata associated with the first data from one or more data sources, generating a virtual object, setting a state of the adjustable aspect such that the adjustable aspect is a visual representation of one or more aspects of the one or more of the first data or the first metadata, causing a user device to output the virtual object via a user interface, determining a change in one or more of the first data or the first metadata, modifying the state of the adjustable aspect based on the determined change, and causing the user device to modify the output of the virtual object based on the modified state of the adjustable aspect.

### TECHNICAL FIELD

Various embodiments of this disclosure relate generally to generating a dynamic virtual representation of an event or an object and, more particularly, to systems and methods for modifying adjustable aspects of a virtual object based on first data and/or first metadata and outputting the virtual object to a user interface.

### BACKGROUND

Visual representations of numerical values often provide little context to a viewer or may be confusing to interpret. Without some context, or even some interesting element that makes the visual representation more relevant to the viewer, the importance of the numerical value may not be fully appreciated. Conventional techniques, including the foregoing, fail to account for the confusion in presentation of visual representations of numerical values. Without a clear and interesting way to visualize numerical values, viewers may not fully appreciate the value or any change in the value.

Further, the way in which people are interacting with data and computers is changing. For example, virtual and/or augmented reality spaces have become increasingly prevalent. However, conventional techniques for utilizing such spaces to view and interact with data may be unintuitive or confusing, or may not provide such data in a way that leverages the benefits possible with a virtual or augmented reality space.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating a dynamic virtual representation of an event or an object.

In one aspect, a non-transitory computer-readable medium is disclosed. The non-transitory computer-readable medium may include storing instructions that, when executed by a processor, cause the processor to perform a method for generating a dynamic virtual representation of an event or an object, the method including: obtaining one or more of first data or first metadata associated with the first data from a plurality of data sources, wherein: the first data includes one or more of a numerical representation of (i) an event or (ii) a changeable characteristic of an object; and portions of the one or more of the first data or the first metadata from different sources of the plurality of sources are in different forms; normalizing to a common form the portions of the one or more of the first data or the first metadata; generating, via one or more processors, a virtual object, the virtual object having at least one adjustable aspect; setting a state of the adjustable aspect such that the adjustable aspect is a visual representation of one or more aspects of the one or more of the first data or the first metadata; causing a user device to output the virtual object via a user interface; determining a change in one or more of the first data or the first metadata; modifying the state of the adjustable aspect based on the determined change; and causing the user device to modify the output of the virtual object based on the modified state of the adjustable aspect.

In another aspect, a method for generating a dynamic virtual representation of an event or an object is disclosed. The method may include obtaining one or more of first data or first metadata associated with the first data from one or more data sources, the first data includes one or more of a numerical representation of (i) an event or (ii) a changeable characteristic of an object; generating, via one or more processors, a virtual object, the virtual object having at least one adjustable aspect; setting a state of the adjustable aspect such that the adjustable aspect is a visual representation of one or more aspects of the one or more of the first data or the first metadata; causing a user device to output the virtual object via a user interface; determining a change in one or more of the first data or the first metadata; modifying the state of the adjustable aspect based on the determined change; and causing the user device to modify the output of the virtual object based on the modified state of the adjustable aspect.

In another aspect, a system for generating a dynamic virtual representation of an event or an object is disclosed. The system may include at least one memory storing instructions; and at least one processor executing the instructions to perform operations for generating dynamic virtual representations an event or an object, the operations including: obtain one or more of first data or first metadata associated with the first data from one or more data sources, the first data includes one or more of a numerical representation of (i) an event or (ii) a changeable characteristic of an object; generate a virtual object, the virtual object having at least one adjustable aspect; set a state of the adjustable aspect such that the adjustable aspect is a visual representation of one or more aspects of the one or more of the first data or the first metadata; store, at a portable device associated with a user device, one or more of the first data, the first metadata, or the virtual object; cause the user device to output the virtual object via a user interface; determine a change in one or more of the first data or the first metadata; modify the state of the adjustable aspect based on the determined change; and cause the user device to modify the output of the virtual object based on the modified state of the adjustable aspect; wherein each of causing the user device to output the virtual object and causing the user device to modify the output of the virtual object includes obtaining the virtual object from the portable device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for generating a dynamic virtual representation of an event or an object, according to one or more embodiments.

FIG. 2A depicts an exemplary method for generating a dynamic virtual representation of an event or an object, according to one or more embodiments.

FIGS. 2B-2D depict an exemplary virtual space displaying example dynamic virtual representations of an event or an object, according to one or more embodiments.

FIGS. 3A-3C depict an exemplary user device displaying example dynamic virtual representations of an event or an object, according to one or more embodiments.

FIG. 4 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Terms like “normalization” or the like generally encompass adjusting values measured on different scales to a notionally common scale.

According to an example implementation, a device may be configured to interact with the metaverse, e.g., with a virtual object in the metaverse. In some embodiments, the device may be portable (e.g., handheld) and include built-in technology, such as a soft wallet, Wi-Fi capabilities, a camera, an emergency service connection, a user interface, e.g., a graphical user interface (GUI), etc. The GUI may be configured to display a virtual object, non-fungible tokens, cash balance in a bank account, cryptocurrency, etc. The device may include various applications and/or functionalities to provide benefits to the user, such as to aid in burnout prevention (e.g., mindfulness alerts), to develop new skills (e.g., coding skills), to connect users with peers and/or family members, etc. For example, the device may be configured to send a ping to a desktop device, e.g., a laptop computer, to remind a user to take a break from work every few hours.

In an exemplary use case, a user may wish to visually depict their child's age over time using a virtual object in a virtual or augmented reality space, e.g., via the above-described device. The virtual and/or augmented reality space may be specific to the user, associated with a user group, or a publicly available space. The user may select a virtual object and an adjustable aspect of the virtual object, and may input the child's age into an account, e.g., an account on the device. For example, the user may select a birthday cake as the virtual object and the adjustable aspect as the number of candles on the cake, such that for each year of the child's life, a candle is added to the cake. The virtual birthday cake and candles may be displayed via the GUI.

In another exemplary use case, a user may wish to visually depict progress toward a financial goal, e.g., saving money to buy a boat. The device may automatically select a boat as the virtual object and the completeness of the boat image as an adjustable state. The user may link a bank account to the system such that when money is added to or removed from the bank account, the completeness of the boat image may be modified. For example, as the user adds more money to the bank account, the image of the boat may become more complete until the goal is reached. If the user withdraws money from the bank account, the image of the boat may become less complete. If the user reaches their financial goal, the boat may become a complete image and/or become animated. The boat may be displayed via the user device, e.g., via the GUI.

In a further exemplary use case, a portable device acts as a real-world link to a virtual object and/or a virtual space. The portable device may depict a representation of an object or character that may also be represented in the virtual space. The portable device may enable a user to interact with or view data from an activity associated with the virtual space without having to enter the virtual space. The portable device may act as a storage unit for data or metadata associated with the virtual object and/or the virtual space. The portable device may act as a validation token, cryptography key, electronic wallet, message channel, etc. The portable device may be configured to use Wi-Fi and/or a mobile device communication channel, e.g., a cellular network, and/or may be usable to contact other users and/or emergency services.

While the examples above involve generating a virtual object based on age or a financial goal, it should be understood that techniques according to this disclosure may be adapted to any suitable virtual representation (e.g., showing change over time, showing progress toward a goal, etc.). It should also be understood that the examples above are illustrative only. The techniques and technologies of this disclosure may be adapted to any suitable activity. Presented below are various systems and methods of generating a dynamic virtual representation of an event or an object.

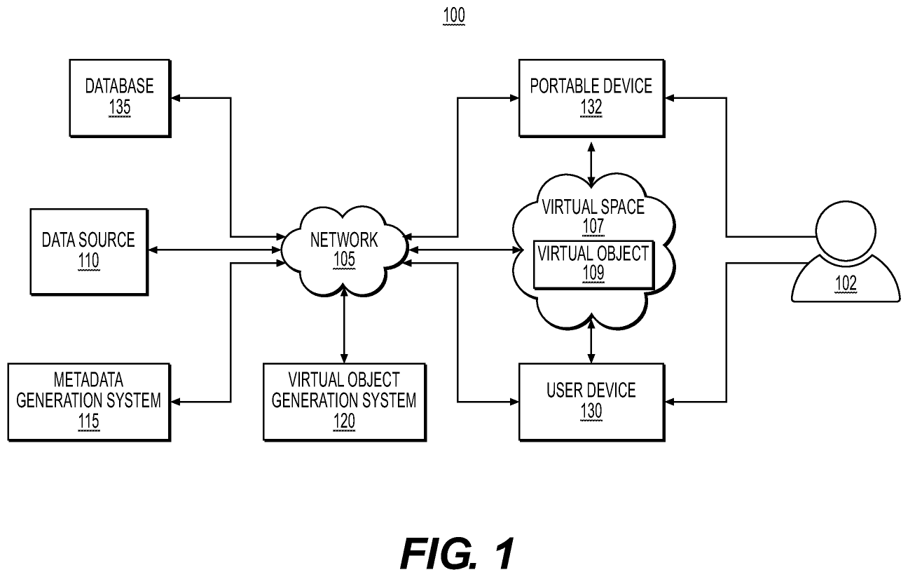

FIG. 1 depicts an exemplary environment for generating a dynamic virtual representation of an event or an object, according to one or more embodiments. Environment 100 for FIG. 1 depicts a user 102, a network 105, a virtual space 107, a data source 110, a metadata generation system 115, a virtual object generation system 120, a user device 130, a portable device 132, and a database 135.

One or more of the components in FIG. 1 may communicate with each other and/or other systems, e.g., across network 105. In some embodiments, network 105 may connect one or more components of environment 100 via a wired connection, e.g., a USB connection between data source 110 and user device 130. In some embodiments, network 105 may connect one or more aspects of environment 100 via an electronic network connection, for example a wide area network (WAN), a local area network (LAN), personal area network (PAN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. In any case, the connections within the environment 100 may be network, wired, any other suitable connection, or any combination thereof.

Virtual space 107 may be configured to display at least a virtual object 109. In some embodiments, virtual space 107 may be configured to connect aspects of environment 100 to a virtual world and/or a virtual reality. A virtual space, virtual world, or virtual reality may refer to a computer-simulated environment that may present perceptual stimuli, e.g., virtual object 109, to a user and/or enable users to manipulate the elements of the computer-simulated environment. Virtual object 109 may be a virtual representation of an object or event. In some embodiments, virtual space 107 may be accessible using other aspects of environment 100, e.g., using user device 130 and/or portable device 132.

Data source 110 may be configured to obtain inputs of data and/or metadata, e.g., data and/or metadata related to a bank account for user 102. Data source 110 may receive inputs from other aspects of environment 100, e.g., user device 130, and/or from other sources, e.g., third party systems. For example, data source 110 may obtain bank account data from a third party database or server that may be implementing that bank account. Data source 110 may communicate data to other aspects of environment 100, e.g., to metadata generation system 115.

Metadata generation system 115 may be configured to generate metadata. For example, metadata generation system 115 may generate metadata based on data received from one or more bank accounts of user 102. For example, for first data relating to data received from one or more bank accounts, e.g., transaction data and balance data, metadata generation system 115 may generate metadata such as an aggregate spending amount, or the like. Metadata generation system 115 may receive inputs from other aspects of environment 100, e.g., data source 110, and/or from other sources, e.g., user accounts. Metadata generation system 115 may output data to other aspects of environment 100, e.g., virtual object generation system 120.

Virtual object generation system 120 may be configured to generate one or more virtual representations of an object or event, e.g., virtual object 109, using one or more generation algorithms. For example, virtual object generation system 120 may receive an identification of an object, e.g., from a user and/or via an automated algorithm, and may link an aspect of that object to data and/or metadata. For instance, the virtual object generation system 120 may generate a representation of a tree based on the age of user 102. Virtual object generation system 120 may receive inputs from other aspects of environment 100, e.g., metadata generation system 115 and/or data source 110. Virtual object generation system 120 may output data, e.g., virtual object 109, to other aspects of environment 100, e.g., to virtual space 107 and/or to user device 130.

User device 130 may be configured to access virtual space 107, e.g., by running an access program. User device 130 may be configured to output data, metadata, and/or the one or more virtual representations of an event or object. User device 130 may be a cell phone, a virtual reality headset, a computer, etc. User device 130 may receive inputs, e.g., a virtual representation of an object or event, from one or more systems of environment 100, e.g., virtual object generation system 120. User device 130 may output data and/or the virtual representation, e.g., virtual object 109, to a GUI. In some embodiments, user device 130 may locally store any or all of the data, the metadata, and/or the virtual object. The virtual object and/or a modified virtual object may be accessible via interaction with virtual space 107 using user device 130.

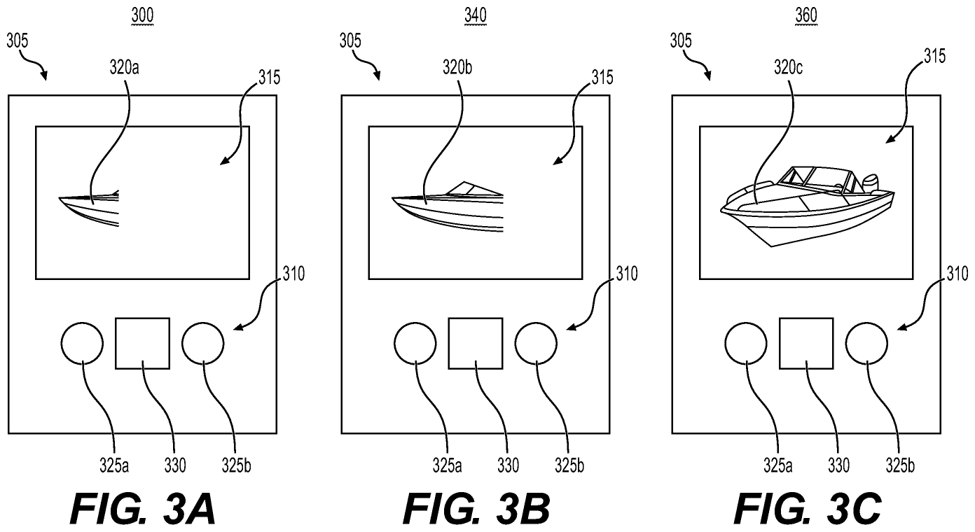

In some embodiments, portable device 132 may be configured as key device to gain access to virtual space 107. Portable device 132 may be configured to output data, metadata, and/or the one or more virtual representations of an event or object, e.g., output virtual object 109 via a GUI. An exemplary portable device 132 is described in more detail below in FIGS. 3A-3C. Portable device 132 may receive inputs, e.g., a virtual representation of an object or event, from one or more systems of environment 100, e.g., virtual object generation system 120. Portable device 132 may output data and/or the virtual representation, e.g., virtual object 109, to a GUI. In some embodiments, portable device 132 may locally store any or all of the data, the metadata, and/or the virtual object. The virtual object and/or a modified virtual object may be accessible via interaction with virtual space 107 using portable device 132.

User device 130 and portable device 132 may interact, e.g., via network 105. In some embodiments, user device 130 may provide access to and display virtual space 107 and portable device 132 may display virtual object 109. For example, portable device 132 may display virtual object 109 and user device 130 may display virtual object 109 within virtual space 107. In some embodiments, either or both of user device 130 modifying virtual object 109 and/or user device 130 outputting virtual object 109 may cause user device 130 to obtain virtual object 109 from portable device 132. In some embodiments, inputs at portable device 132 may alter the representation of virtual object 109 at user device 130 and vice versa. For example, user 102 may input data using one or more controls, e.g. actuators, of portable device 132 that may modify virtual object 109 in some way. The modification may be outputted at portable device 132 and/or user device 130, e.g., via a GUI. In some embodiments, virtual object 109 may be displayed in different dimensions, e.g., two-dimensional and/or three-dimensional, on different devices, e.g., user device 130 and/or portable device 132. For example, virtual object 109 may be two-dimensional when displayed on portable device 132 and three-dimensional when displayed on user device 130.

Although depicted as separate components in FIG. 1, it should be understood that a component or portion of a component in the environment 100 may, in some embodiments, be integrated with or incorporated into one or more other components. For example, metadata generation system 115 may be integrated in user device 130. In another example, virtual object generation system 120 may further include a storage system, e.g., database 135, which may store metadata, virtual representations of an event or object, and/or other relevant data. In some embodiments, operations or aspects of one or more of the components discussed above may be distributed amongst one or more other components. Any suitable arrangement and/or integration of the various systems and devices of the environment 100 may be used.

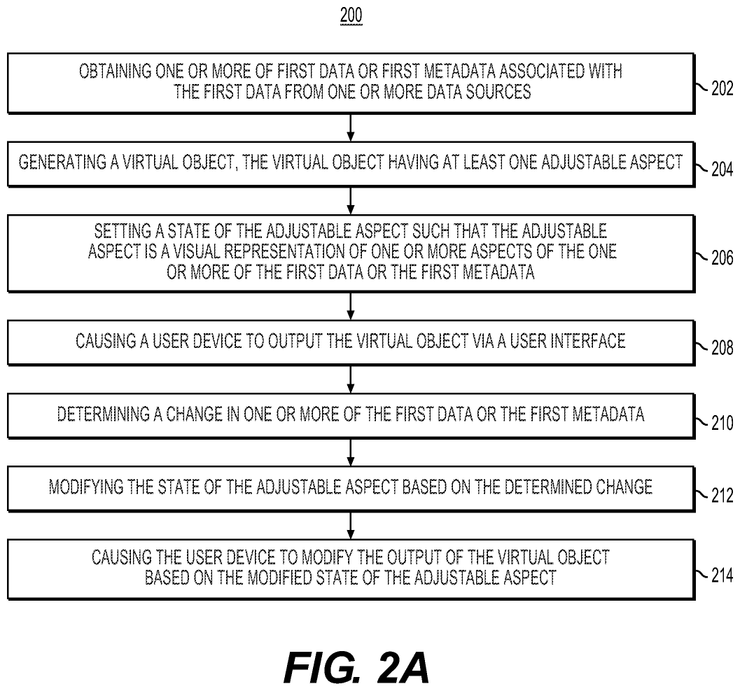

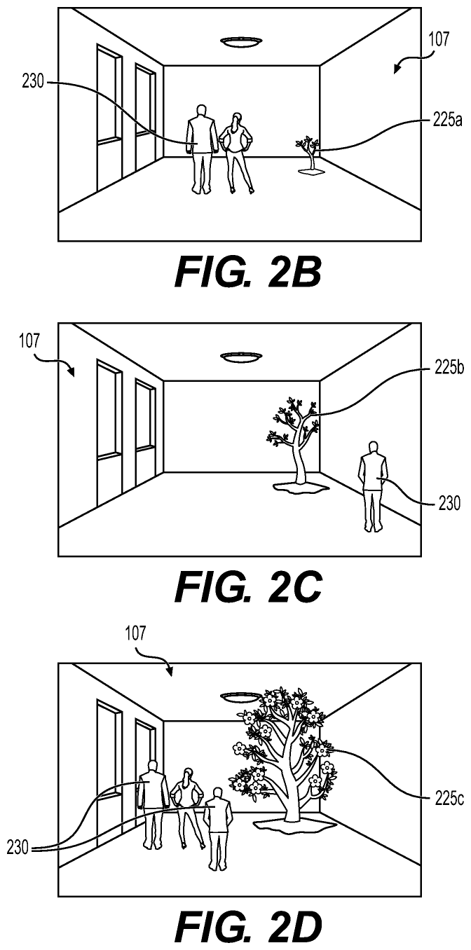

FIG. 2A depicts an exemplary method for generating a dynamic virtual representation of an event or an object, according to one or more embodiments. At step 202, one or more of first data and/or first metadata associated with the first data from one or more data sources may be obtained. The first data and/or first metadata may be obtained from any suitable source, e.g., data source 110, metadata generation system 115, etc. The first data and/or first metadata received from an external source may be obtained via data source 110. For example, in various embodiments, the data source 110 may scrape data from an external source, aggregate data from various other sources, use user credentials or the like to access secured data or decrypt encrypted data, etc.

The first data may include one or more of a numerical representation of an event or a changeable characteristic of an object, e.g., an adjustable aspect as described in more detail below. The first data and/or first metadata may include financial data, bank account deposit data, bank account withdrawal data, credit score data, debt default data, debt repayment data, characteristic data (e.g., age, height, weight, health metric, etc.), change over time data (e.g., how a person's cholesterol has changed over 6 months), etc.

The first data and/or first metadata may be obtained by/from a system, e.g., data source 110, monitoring one or more data and/or metadata sources. For example, data source 110 may monitor, e.g., automatically and/or manually, a user's bank account for a deposit and/or withdrawal, and may obtain data and/or metadata related to the bank account based on the deposit and/or withdrawal.

The first data and/or first metadata may be obtained from a plurality of data sources in various formats. For example, the first data and/or first metadata may be plain text, hypertext, proprietary formats (e.g.,.doc/.docx,.pdf, etc.), encrypted or unencrypted, image formats (e.g., JPEG 2000), database formats (e.g., XML), etc. As such, in some embodiments, the first data and/or first metadata may be normalized to a common form. Any suitable normalization method or combination of methods may be used, e.g., recognizing text, parsing information from data, extracting one or more features from the data, conversion between data formats, etc. The normalized data may be used in subsequent steps of method 200, and/or may be stored, e.g., in database 135.

At step 204, a virtual object having at least one adjustable aspect may be generated. Any suitable aspect of environment 100, e.g., virtual object generation system 120, may generate the virtual object. The virtual object may be any object, such as a two-dimensional or three-dimensional object. The form of the virtual object may be selected by any suitable means, e.g., automatically based on one or more factors (e.g., data and/or metadata associated with data source 110) and/or manually by the user (e.g., from a selection of available virtual objects).

The at least one adjustable aspect may include any aspect of the virtual object, such as any one or more of a shape, a position, a coloration, a visual effect, an animation, an interaction of at least a portion of the virtual object, etc. The virtual object and/or the at least one adjustable aspect may be selected automatically, e.g., based on the first data and/or first metadata, or manually, e.g., by user 102. In a non-limiting example, user 102 may select a tree as the virtual object and virtual object generation system 120 may select the amount, length, and/or color of the branches as the adjustable aspect.

At step 206, a state of the at least one adjustable aspect may be set such that the adjustable aspect may be a virtual representation of one or more aspects of the first data and/or the first metadata. For example, the height of a tree may be set based on the age of a user, such that the tree gets taller each year older a user gets. Any suitable representation may be used, as described in further detail below. At step 208, a user device may output the virtual object. The virtual object may be outputted via any suitable interface, e.g., a GUI of user device 130.

At step 210, a change in one or more of the first data or the first metadata may be determined. In some embodiments, the change may be determined by automatically and/or manually monitoring one or more data sources 110, e.g., third party systems, for one or more of an event, a changeable characteristic of an object, second data, second metadata, an update to the first data, an update to the first metadata, or any combination thereof. The second data and/or second metadata may include updated, new, or newly received financial data, bank account deposit data, bank account withdrawal data, credit score data, debt default data, debt repayment data, characteristic data (e.g., a change in age compared to the first data), change over time data (e.g., a change in the amount of money in a bank account compared to the first data), etc. The second data, second metadata, updated first data, and/or updated first metadata may be obtained by/from a system, e.g., data source 110, monitoring one or more data and/or metadata sources. For example, data source 110 may monitor, e.g., automatically and/or manually, a user's medical records for a change in cholesterol levels, and may obtain data and/or metadata related to the changed cholesterol levels. As described in more detail above in step 202, the second data, second metadata, updated first data, and/or updated first metadata may be normalized to a common form using any suitable method.

At step 212, the state of the adjustable aspect may be modified based on the determined change. In some embodiments, the adjustable aspect may be modified after a determination that the determined change exceeds a threshold. The threshold may be specific to the virtual representation, numerical value, adjustable aspect, etc. Continuing the prior example, if the threshold is one year, the height of the tree may be modified after a year has passed but not if the determined change is 300 days.

At step 214, user device 130 may modify the output of the virtual object based on the modified state of the adjustable aspect. In some embodiments, the virtual object may be modified, e.g., by virtual object generation system 120, and outputted via any suitable interface, e.g., a GUI of user device 130.

In some embodiments, the numerical representations of events and objects, e.g., such as those generated as a result of method 200, may be displayed, stored, contained, etc. in a virtual space, e.g., virtual space 107. FIGS. 2B-2D depict an exemplary virtual space 107 displaying example dynamic virtual representations of an event or an object, according to one or more embodiments. In some embodiments, various users, e.g., one or more users 230, may interact with the dynamic virtual representations of an event or an object with virtual space 107, as depicted in FIGS. 2B-2D.

As depicted in FIGS. 2B-2D, virtual objects 225a, 225b, and 225c may be a tree dynamically modifiable based on a person's age. Virtual object 225a, as depicted in FIG. 2B, may have been generated and have one or more adjustable aspect (step 204) based on data and/or metadata received relating to the person's age (step 202). The one or more adjustable aspect may be the height of the tree (as depicted in FIGS. 2B and 2C) and/or the number of flowers on the tree (as depicted in FIG. 2D). In some embodiments, the height may be adjustable until a threshold is reached, wherein the height may remain static while the tree begins to dynamically blossom, as described in further detail below. As depicted in FIG. 2B, the height may be set (step 206) such that virtual object 225a represents a younger age in comparison to the age represented by virtual object 225b. Virtual object 225a may be output to a user interface (step 208), e.g., to user device 130 and/or to portable device 132.

Data sources 110 may continue to be monitored, as described herein, such that a change in the person's age may be determined (step 210) and virtual object 225a, e.g., an adjustable aspect of virtual object 225a, may be modified based on the change (step 212). As depicted in FIG. 2C, virtual object 225b may reflect the outputted change, e.g., an increase in age, to virtual object 225a and/or to the adjustable aspect of virtual object 225a (step 214). As depicted in FIG. 2C, virtual object 225b may be taller in comparison to virtual object 225a based on the respective age each virtual object represents.

As discussed herein, a virtual object may have one or more adjustable aspects, e.g., a first adjustable aspect, a second adjustable aspect, etc. As depicted in FIG. 2D, virtual object 225c depicts a first adjustable aspect of height and a second adjustable aspect of number of flowers. In some embodiments, the first adjustable aspect and the second adjustable aspect may represent the same or similar event or object. For example, the height of virtual object 225c may represent age until a threshold value, e.g., 21 years old, then the height may remain static and the number of flowers may represent age, e.g., from age 22 onward. In some embodiments, the first adjustable aspect and the second adjustable aspect may represent different events or objects. For example, the height of virtual object 225c may represent age until a threshold value, e.g., 18 years old, then the number of flowers may represent a different value, such as the number of countries visited, e.g., one flower for each country visited after the person's eighteenth birthday.

While many of the examples above involve one or two adjustable aspects based on age, it should be understood that techniques according to this disclosure may be adapted to any suitable virtual object, number of adjustable aspects, or representation of one or more event or object. It should also be understood that the examples above are illustrative only. The techniques and technologies of this disclosure may be adapted to any suitable activity or variation.

It should be noted that any change and/or modification may be implemented at steps 210-214. While many of the examples provided above include discussion of an increase in the numerical value being represented by the virtual object and/or adjustable aspect, it should be noted that a decrease in the numerical value may also be represented, as discussed in further detail below.

Any combination of virtual objects and adjustable aspects may be used to generate a dynamic virtual representation of an event or an object, e.g., a tree and amount of foliage on the tree, an avatar and a height of the avatar, a painting and a vibrancy of its colors, etc. FIGS. 3A-3C depict an example of a boat where the adjustable aspects are the completeness of the image and, upon completion of a fund raising goal, animation of the image.

FIGS. 3A, 3B, and 3C depict an exemplary user device displaying example dynamic virtual representations of an event or an object, according to one or more embodiments. FIGS. 3A-3C depict a user device 305 with one or more controls 310 and a user interface 315. The one or more controls 310 may be, in some embodiments, actuators, e.g., actuators 325a and 325b, and/or an identification sensor 330. The actuators 325a and 325b may be configured to modify the state of the adjustable aspect. For example, actuator 325a may increase the height of a tree while actuator 325b may decrease the height of a tree or vice versa. Identification sensor 330 may be configured to determine, e.g., confirm, the identification of user 102. Identification sensor 330 may use any suitable identification sensor and/or technique, e.g., facial recognition, multi-factor authentication, capacitive touch, etc.

User interface 315 may be configured to display the virtual object based on the state of the adjustable aspect, as discussed above in FIG. 2A. In an example, a bank account to purchase a boat may be established. As such, the virtual object may be a boat, the adjustable aspects may be the completeness of the boat and the animation of the boat, and the adjustable aspects may be representative of the amount of money in a bank account. FIG. 3A may depict virtual object 320a as a partially completed depiction of the boat, e.g., based on user 102 saving approximately one-third of the necessary amount. FIG. 3B may depict virtual object 320b as a modified depiction of the boat, e.g., based on user 102 saving approximately two-thirds of the necessary amount, as described in steps 210-214 above. FIG. 3C may depict virtual object 320c as a completed depiction of the boat, e.g., based on user 102 saving at least the necessary amount to buy the boat. In some embodiments, virtual object 320c may be displayed as an animated version of the boat once the fundraising goal is reached.

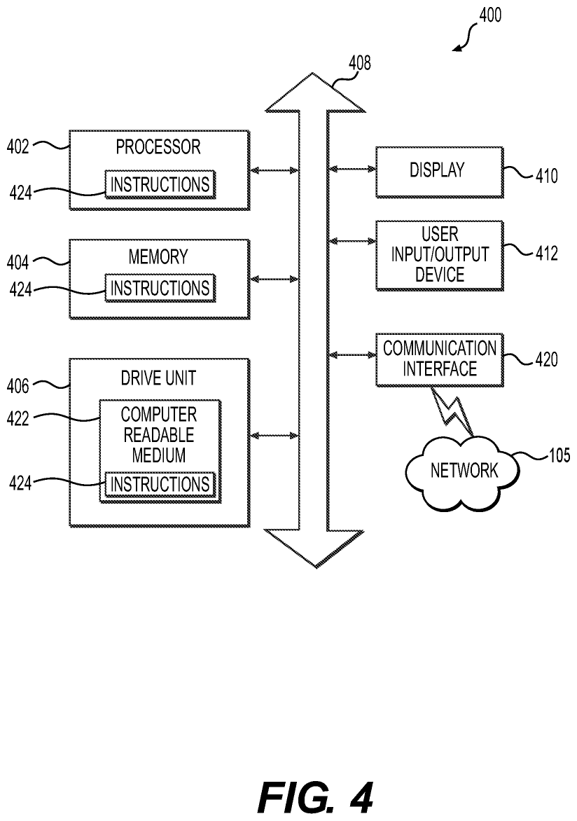

FIG. 4 depicts a simplified functional block diagram of a computer 400 that may be configured as a device for executing the methods disclosed here, according to exemplary embodiments of the present disclosure. For example, the computer 400 may be configured as a system according to exemplary embodiments of this disclosure. In various embodiments, any of the systems herein may be a computer 400 including, for example, a data communication interface 420 for packet data communication. The computer 400 also may include a central processing unit (CPU) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A non-transitory computer-readable medium storing instructions that, when executed by a processor, cause the processor to perform a method for generating a dynamic virtual representation of an event or an object, the method comprising:
obtaining one or more of first data or first metadata associated with the first data from a plurality of data sources, wherein:
the first data includes one or more of a numerical representation of (i) an event or (ii) a changeable characteristic of an object; and
portions of the one or more of the first data or the first metadata from different sources of the plurality of sources are in different forms;
normalizing to a common form the portions of the one or more of the first data or the first metadata;
generating, via one or more processors, a virtual object, the virtual object having at least one adjustable aspect;
setting a state of the adjustable aspect such that the adjustable aspect is a visual representation of one or more aspects of the one or more of the first data or the first metadata;
causing a user device to output the virtual object via a user interface;
determining a change in one or more of the first data or the first metadata;
modifying the state of the adjustable aspect based on the determined change; and
causing the user device to modify the output of the virtual object based on the modified state of the adjustable aspect.

2. The non-transitory computer-readable medium of claim 1, further comprising:
causing a portable device associated with the user device to output a further representation of the virtual object.

3. A method for generating a dynamic virtual representation of an event or an object, the method comprising:
obtaining one or more of first data or first metadata associated with the first data from one or more data sources, the first data includes one or more of a numerical representation of (i) an event or (ii) a changeable characteristic of an object;
generating, via one or more processors, a virtual object, the virtual object having at least one adjustable aspect;
setting a state of the adjustable aspect such that the adjustable aspect is a visual representation of one or more aspects of the one or more of the first data or the first metadata;
causing a user device to output the virtual object via a user interface;
determining a change in one or more of the first data or the first metadata;
modifying the state of the adjustable aspect based on the determined change; and
causing the user device to modify the output of the virtual object based on the modified state of the adjustable aspect.

4. The method of claim 3, wherein the first data includes one or more of financial data, bank account deposit data, bank account withdrawal data, credit score data, debt default data, or debt repayment data.

5. The method of claim 3, further comprising:
receiving an update to the one or more of the first data or the first metadata from a system configured to automatically monitor the one or more of the event or the changeable characteristic of the object.

6. The method of claim 3, wherein:
the one or more data sources includes a plurality of data sources;
portions of the one or more of the first data or the first metadata from different sources of the plurality of sources are in different forms; and
the method further comprises:
normalizing to a common form the portions of the one or more of the first data or the first metadata.

7. The method of claim 3, further comprising:
storing, at a portable device associated with the user device, any of the first data, the first metadata, or the virtual object, wherein each of causing the user device to output the virtual object and causing the user device to modify the virtual object includes obtaining the virtual object from the portable device.

8. The method of claim 3, wherein the determined change is determined based on at least one or more of second data, second metadata, an update to the first data, or an update to the first metadata.

9. The method of claim 3, wherein the modified virtual object is stored in a memory so as to be accessible via interaction with a virtual space.

10. The method of claim 3, wherein the adjustable aspect includes one or more of a change in shape, a change in position, a coloration or visual effect, an animation, or an interaction of at least a portion of the virtual object.

11. The method of claim 3, wherein upon determining that the determined change exceeds a threshold, modifying a further adjustable aspect of the virtual object.

12. The method of claim 3, further comprising:
causing a portable device associated with the user device to output a further representation of the virtual object.

13. A system, the system comprising:
at least one memory storing instructions; and
at least one processor executing the instructions to perform operations for generating dynamic virtual representations an event or an object, the operations including:
obtain one or more of first data or first metadata associated with the first data from one or more data sources, the first data includes one or more of a numerical representation of (i) an event or (ii) a changeable characteristic of an object;
generate a virtual object, the virtual object having at least one adjustable aspect;
set a state of the adjustable aspect such that the adjustable aspect is a visual representation of one or more aspects of the one or more of the first data or the first metadata;
store, at a portable device associated with a user device, one or more of the first data, the first metadata, or the virtual object;
cause the user device to output the virtual object via a user interface;
determine a change in one or more of the first data or the first metadata;
modify the state of the adjustable aspect based on the determined change; and
cause the user device to modify the output of the virtual object based on the modified state of the adjustable aspect;
wherein each of causing the user device to output the virtual object and causing the user device to modify the output of the virtual object includes obtaining the virtual object from the portable device.

14. The system of claim 13, wherein the first data includes one or more of financial data, bank account deposit data, bank account withdrawal data, credit score data, debt default data, or debt repayment data.

15. The system of claim 13, further comprising:
receiving an update to the one or more of the first data or the first metadata from a system configured to automatically monitor the one or more of the event or the changeable characteristic of an object.

16. The system of claim 13, wherein:
the one or more data sources includes a plurality of data sources;
portions of the one or more of the first data or the first metadata from different sources of the plurality of sources are in different forms; and
the system further comprises:
normalizing to a common form the portions of the one or more of the first data or the first metadata.

17. The system of claim 13, wherein the determined change is determined based on at least one or more of second data, second metadata, an update to the first data, or an update to the first metadata.

18. The system of claim 13, wherein the modified virtual object is stored in a memory so as to be accessible via interaction with a virtual space.

19. The system of claim 13, wherein the adjustable aspect includes one or more of a change in shape, a change in position, a coloration or visual effect, an animation, or an interaction of at least a portion of the virtual object.

20. The system of claim 13, wherein upon determining that the determined change exceeds a threshold, modifying a further adjustable aspect of the virtual object.
